(19) United States
(12) Patent Application Publication
(10) Pub. No.: US 2020/0129798 A1
(43) Pub. Date: Apr. 30, 2020

(54) THERMAL TRIGGERING ELEMENT

(71) Applicant: JOB LIZENZ GMBH & CO. KG, Ahrensburg (DE)

(72) Inventors: Rüdiger KLUG, Ahrensburg (DE); Jürgen TESCHNER, Hamburg (DE); Bodo MÜLLER, Tornesch (DE)

(73) Assignee: JOB LIZENZ GMBH & CO. KG, Ahrensburg (DE)

(21) Appl. No.: 16/619,529

(22) PCT Filed: Jun. 19, 2018
(86) PCT No.: PCT/EP2018/066299

§ 371 Date: Dec. 5, 2019

(30) Foreign Application Priority Data
Jun. 21, 2017 (DE) 20 2017 103 682.0

(51) Int. Cl. A62C 37/14

(52) U.S. Cl. CPC A62C 37/14; H01H 37/36

(57) ABSTRACT

A thermal triggering element having a vessel body with an outer wall formed from a rupturing material, and having a cavity enclosed by the outer wall and situated in the interior of the vessel body, and in which a triggering liquid is enclosed. The vessel body is formed so as to extend along an axial direction, with a tubular central section extending in the axial direction, and with two end sections located at the respective axial ends and in which the cavity is closed off in the manner of a cap. In order for the thermal triggering element to be protected against damage by shocks, the triggering element has a permanently acting reinforcement which reinforces the rupturing material with respect to shock loads acting transversely with respect to the longitudinal direction.

### TECHNICAL FIELD

The invention relates to a triggering element having a vessel body having an outer wall formed from a rupturing material, and having a cavity, which is enclosed by the outer wall and which is situated in the interior of the vessel body and in which a triggering liquid is enclosed, wherein the vessel body is formed so as to extend along an axial direction, with a tubular central section extending in the axial direction, and with two end sections which are situated at the respective axial ends and in which the cavity is closed off in the manner of a cap.

### BACKGROUND

### Background Information

Thermal triggering elements have long been well-known and used. They are particularly used in great number in sprinkler and fire-extinguishing systems, where they are arranged on outlet nozzles and/or sprinkler outlets connected to pipelines filled, under pressure, with an extinguishing agent (normally water), said nozzles and outlets being retained in their closed position, in an axial direction between a counter bearing and a closing element, the closing element being retained in a closed position. If the outside temperature increases to above the triggering temperature to be set though corresponding and known technological measures, the rupturing material of the outer wall is destructed by the pressure, which increases with the temperature increase and is established by the triggering liquid, and the triggering element ruptures and enables a path for opening the closing element such that the extinguishing agent can exit and be discharged from the sprinkler nozzles and/or the sprinkler outlets.

In addition to a use in such sprinkler and/or fire-extinguishing systems, applications are also known and described in which such triggering elements close off pressure-relief openings, in order to release them at a triggering temperature increasing above a critical temperature, e.g. in order to empty the pressurized gas container in the event of fire before they can explode, for example. Applications of such triggering elements are also known in association with the interruption of the electrical current flow. Further applications are conceivable; such triggering elements can always be used when temperature-sensitive mechanical switch settings must be changed or electrical lines must be disconnected.

The typical non-thermal triggering elements of the aforementioned type, which have been well-known for many years and of which one is shown and described, for example, in DE 36 01 203 A1, are frequently made of glass. Glass is thus the rupturing material in these cases.

Thermal triggering elements of the aforementioned type are controlled technologically very well today. Very easily adjustable triggering temperatures can be achieved with a low tolerance threshold. In addition, the response times can be set very low; thermal triggering elements of this type of very low thermal inertia can be produced.

However, a problem in this case is that the thermal triggering elements are shock-sensitive, particularly with respect to shocks transverse to the longitudinal direction thereof, especially in a previously installed position in a closing element (e.g. a sprinkler head or a valve cap for pressure-relief openings). Thus, it is still possible that such a shock is unintentionally exerted onto the outer wall of the thermal triggering element such that damage occurs during handling such a thermal triggering element and/or assembly, in which said triggering element is already integrated (e.g. in a sprinkler head of a sprinkler system) in a closing position. This can result in the formation of a crack or even lead to a fracture of the triggering element. In both cases, the triggering element will then no longer function; the assembly can no longer be used. If the outer wall of the thermal triggering element merely develops a crack or another comparable type of damage, this is especially fatal because it can remain unnoticed but subsequent proper function of the triggering element is no longer ensured. For example, the triggering liquid could escape from the interior of the triggering element over time due to such a crack such that the triggering element loses its function completely.

This danger is counteracted sometimes today in that mounting securing mechanisms, e.g. in the form of clipped-on protective collars, which then must be removed after handling in order to obtain the functionality of the triggering elements, are placed on the thermal triggering elements for installation. However, this procedure has the danger that removal of these mounting securing mechanisms might be forgotten and thus the function of the triggering element would be disabled. Moreover, this measure is also not effective for handling the thermal triggering elements already installed in the environment of, for example, a sprinkler system as takes place, for example, within the scope of maintenance work or even simply by accident.

### SUMMARY

The invention is intended to provide a remedy for this in that the thermal triggering element should be rendered non-sensitive, or at least less sensitive, with respect to shocks and influences as previously mentioned without it being necessary, for example, to attach a temporary mounting securing mechanism.

This object is achieved by means of a thermal triggering having a permanently acting reinforcement which reinforces the rupturing material with respect to shock loads acting transversely with respect to the longitudinal direction. Advantageous further embodiments of such a triggering element according to the invention are that the reinforcement contains auxetic material, wherein the auxetic material is oriented in a manner such that it exhibits a reinforcing effect on the outer wall upon an external application of force directed transversely with respect to the axial direction. The reinforcement has one or more dilatant liquids or a material produced therefrom, e.g. a foam. The reinforcement) has a material which is solid and stiff in a temperature range below an intended triggering temperature of the triggering element, and which is flexible at the triggering temperature. The reinforcement has a textile structure, which is produced, impregnated, or coated with an auxetic material, one or more dilatant liquids, or a material produced from one or more dilatant liquids, and/or a material which is solid and stiff in a temperature range below an intended triggering temperature of the triggering element, and which is flexible at the triggering temperature. The reinforcement comprises a coating applied to the outer side of the outer wall or a collar placed on the outer side of the outer wall, or a protective curtain arranged on the outer side of the outer wall. The reinforcement is provided essentially along the entire central section. The reinforcement is a water-soluble material or a water-soluble carrier material. The rupturing material is glass.

According to the invention, the thermal triggering element thus has a vessel body, which comprises an outer wall formed from a rupturing material. A cavity, in which a triggering liquid is contained, is enclosed by the outer wall in the interior of the vessel body. A gas bubble, particularly an air bubble, may be contained therein. The vessel body is expansively formed along an axial direction and has a tubular central section extending in the axial direction. An end section is placed at the respective axial ends, thus a total of two end sections, in which the cavity is closed off in the manner of a cap. In this respect, the construction according to the invention of the thermal triggering element conforms with the variants known from the prior art.

The special feature of the triggering element according to the invention then exists in that the triggering element has a reinforcement, which reinforces the rupturing material with respect to shock loads acting transversely with respect to the longitudinal direction. This reinforcement is permanently placed on the triggering element in this case, e.g. placed directly onto the rupturing material, or integrated into the rupturing material and in this respect differs from a mounting securing mechanism to be temporarily applied. Permanent in terms of this invention means that the reinforcement remains active and effective in any case as long as the thermal triggering element has not yet reached the range of its triggering temperature or has even already been triggered. Thermal triggering elements are frequently installed for several years, even decades, for example in sprinkler systems, and remain in use therein. The reinforcement should remain effective during such a typical span of usage as long as the thermal triggering element is not in the range of a triggering temperature or has already been triggered in any case.

The reinforcement provided according to the invention thus provides targeted protection of the thermal triggering element from damage or destruction from typically unintentional shock effect acting externally transversely with respect to the axial direction of the triggering element. In doing so, the reinforcement, however, is selected in a manner such that it does not obstructively stand in the way of the desired triggering process at high temperatures, and this is provided even though the reinforcement is not merely temporary but provided with the thermal triggering element over a timeframe of installation and beyond. In particular, the reinforcement provided according to the invention is designed such that the pressure in the interior of the cavity resulting from the heated triggering liquid continues to reliably ensure destruction of the rupturing material and thus a triggering of the thermal triggering element at the specified triggering temperature. This can be achieved, for example, in that an application of pulse or force in a direction starting from the cavity going outward is generally not obstructed by the reinforcement, or also, however, in that the reinforcement loses all of its effect at high temperatures, particularly within the range of the triggering temperature, or the reinforcement does not completely enclose the thermal triggering element.

A possibility of forming a reinforcement according to the invention is provided in that it contains auxetic material, wherein this material is oriented in a manner such that it exhibits a reinforcing effect on the outer wall upon an external application of force directed transversely with respect to the axial direction. Compared to conventional materials, an auxetic material is characterized by abnormal behavior in that it does not become thinner in the material layer upon extension normally also only in certain preferential directions of the material but forms a thicker material layer there. Corresponding materials are already known; they exist at the macroscopic level but are also described even in the molecular range, particularly in the form of so-called prisms. Auxetic materials are described and offered on the market by various providers. An alternative or additional possibility of obtaining the reinforcement exists in forming this reinforcement with the use of one or more dilatant liquids or a material produced therefrom, for example a foam. Dilatant liquids are those liquids which change their flexibility and deformability upon the application of force. In particular, such liquids may be solid and rigid with suddenly occurring forces and have energy-absorbing qualities. The functional principle in this case stems from atomic bonds in the molecular structure, which form under pressure and again dissolve after the application of force is over. Foams or comparable materials, for example, may be produced using such liquids, which can be used for the formation of the reinforcement according to the invention when the liquids themselves cannot be used as the reinforcement.

A further possibility of implementing the reinforcement according to the invention exists in that it has a material, which is solid and stiff in a temperature range below an intended triggering temperature of the triggering element, i.e. is capable of absorbing shocks and thus protecting the triggering element, but is flexible, however, at the triggering temperature. Such materials may be plastics, for example, with correspondingly low softening or melting points, which form a solid protective layer or reinforcement at a typical ambient temperature, particularly room temperature, but which soften at higher temperatures and are soft and flexible enough, no later than at the triggering temperature, such that they no longer obstructively stand in the way of a rupturing of the rupturing material, from which the triggering element is formed.

In order to form the reinforcement, it may particularly be provided that it has a textile structure produced, impregnated, or coated with one or more of the previously described materials. A textile structure in this case may be a thread, which is wound, for example, about the triggering element or a partial section of same in order to form the reinforcement. A textile collar may be used, which is placed or slipped over the triggering element.

The reinforcement provided according to the invention may be a coating applied to the outer wall, or a collar placed on the outer side of the outer wall, or a protective curtain arranged on the outer side of the outer wall. Alternatively, the reinforcement may of course also be integrated into the rupturing material; however, the placement of a coating and/or the placement of a collar or of a protective curtain according to the current art is significantly easier to realize and correspondingly more economical to implement. Corresponding coatings may be applied to an otherwise completely finished triggering element in the manner of an immersion bath. Spraying with a coating material or foaming of a coating material is also possible. Basically, any conceivable coating mechanisms can be selected here. Optionally, an adhesive layer can be applied before the application of the actual coating.

The reinforcement may be applied over the entire surface of the thermal triggering element, but this is not a necessity. It can likewise easily be provided, however, also only in sections, preferably in such sections that are particularly at risk for shocks transverse to the axial direction. In this regard, it is preferable that the reinforcement is provided substantially along the entire central section.

In order to ensure use of the thermal triggering element according to the invention in a sprinkler head such that, upon triggering of the thermal triggering element and activating of the sprinkler, the material of the reinforcement does not get caught, for example, on a distribution and/or spraying disc of the sprinkler and impede or impact the distribution of the exiting extinguishing water, it may be provided that the reinforcement consists of a water-soluble material or contains a water-soluble carrier material. Advantageously, the water-solution properties are then determined such that the material does not weaken or trigger based on slight moisture as can result, for example, from condensate or the like. Thus, it is ensured that the protective effect of the reinforcement is retained such that the material only triggers when it comes into contact with a significant quantity of water, which can occur with a triggering of the sprinkler.

Preferably, glass is provided as the rupturing material. However, a different material may also be used which has the corresponding rupture properties.

### BRIEF DESCRIPTION OF THE SEVERAL VIEWS OF THE DRAWINGS

Further advantages and features of the inventions result from the following description of exemplary embodiments by means of the enclosed figures. The following is shown:

FIG. 1 a schematic representation of a thermal triggering element according to the invention in a longitudinal section;

FIG. 2 a cross-sectional representation, comparable to FIG. 1, of a thermal triggering element with an alternative reinforcement;

FIG. 3 a representation, comparable to FIG. 1, of a thermal triggering element with a further alternative reinforcement, wherein the triggering element in this case is not sectionally shown;

FIG. 4 a representation, comparable to FIG. 3, of a thermal triggering element with a further alternative reinforcement; and

FIG. 5 a representation, comparable to FIG. 3, of a thermal triggering element with a further alternative reinforcement.

### DETAILED DESCRIPTION

The figures show purely schematic representations, which are intended to explain the invention, and are in no way true to scale or accurate in detail.

The figures each show a thermal triggering element, which is a glass vessel here, as is basically known from the prior art. Thus, the glass vessel shown here corresponds in design substantially with the form and characteristics described in DE 36 01 203.

A vessel body 1 of the glass vessel completely encloses a cavity 2 with an outer wall 7 and is divided into a central section 8, which is tubular and extends longitudinally in an axial direction, as well as two end sections 3, 4, which are formed at the respective axial ends of the central section 8, within said end sections the cavity 2 is closed off in the manner of a cap. In the exemplary embodiment shown, the end sections 3, 4 as such are shown with material thicknesses (of a diameter expansion as compared to the central section 8). However, these thickenings are not necessary. The end sections 3, 4 may just as well be formed with a diameter that is unchanged as compared to the central section 8 that is formed without the thickenings shown here.

A triggering liquid is arranged within the cavity 2, not shown here, as well as a gas bubble. The outer wall 7 of the vessel body 1 is produced from a rupturing material, particularly glass in this case. The glass vessel with its vessel body has a total length of about 12 to 50 mm in this exemplary embodiment.

In its use as a triggering element, with the end sections 3 and 4 opposite one another at bearing elements 5 and 6, the glass vessel is clamped between them. These bearing elements 5, 6 are not a component of the thermal triggering element but are parts of an assembly, in which the triggering element is used, e.g. of a sprinkler head or of a pressure-relief valve of a gas container. In particular, one of the bearing elements 5, 6, e.g. bearing element 5, may be a valve disk of a sprinkler, while the other bearing element, e.g. bearing element 6, may be a bearing bracket opposite said bearing element, as is to be encountered frequently in sprinkler systems. In a similar manner, the glass vessel, however, may also be integrated, as a thermal triggering element, into an emergency release valve of a gas container or in similar devices. Such components are known to one skilled in the art such that the specific design and function thereof does not have to be further discussed at this juncture.

If there is an increased temperature in the environment of the outer wall 7, with the temperature enabling the triggering fluid to generate sufficient high-pressure in the interior of the cavity 2 to rupture the existing outer wall 7 from the rupturing material, the vessel body 1 of the glass vessel ruptures in a known manner. Thus, the destructed glass vessel exposes, for example, a distance between the bearing elements 5, 6 between which it is arranged. In the case of a sprinkler system, the closing element of the sprinkler nozzle may deflect the applied pressure of the sprinkler liquid, which opens the nozzle. In the case of an emergency release valve for a gas container, for example, under pressure, this valve opens and gas can flow out of the container in a controlled manner.

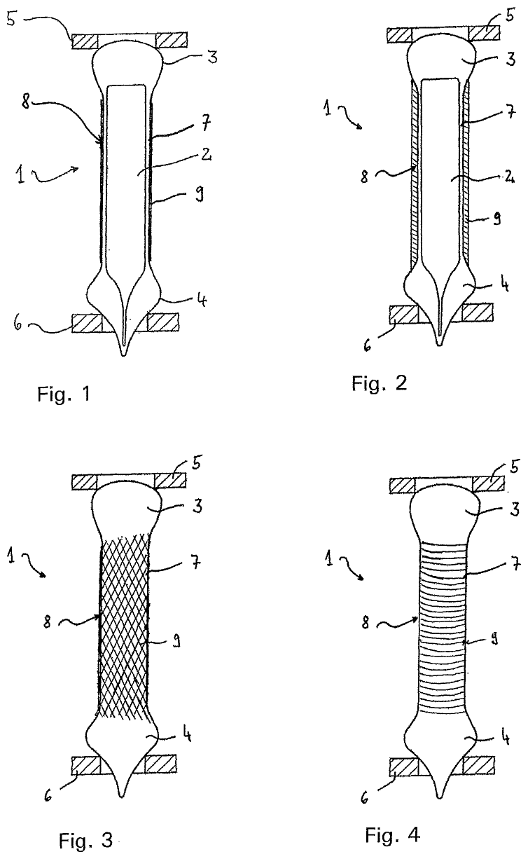

A reinforcement 9 of the vessel body 1 is then essential to the invention. This reinforcement is permanently formed in the manner previously described. The reinforcement 9 in the exemplary embodiments shown is implemented in different forms. Thus, the reinforcement is implemented in the form of a coating on the outer wall 7 in the central section 8 in the example according to FIG. 1. This may be from, for example, an auxetic polymer. The coating can be applied through immersion, brushing, printing, or even through spraying.

FIG. 2 shows an example in which the reinforcement 9 is formed from a protective material containing a textile carrier structure. For example, the textile carrier structure may be soaked, impregnated, or coated with an auxetic material or a dilatant liquid. This textile carrier structure, e.g. a textile fabric, may be applied to the glass vessel 1 as a type of coating, optionally with prior application of an adhesive primer, to which the carrier structure then adheres and thus is secured on the glass vessel 1. The textile carrier structure treated in the previous manner may be prepared such that a shock protection results, which is effective in three dimensions (e.g. by means of an auxetic material arranged such that it is effective in three dimensions).

FIG. 3 shows a design in which the reinforcement 9 has the form of a collar of material webs extending diagonally crosswise in this case. This material webs may then, in turn, be formed from an auxetic-acting material, a material formed with a dilatant liquid (e.g. a foam formed therefrom), or from a material which hardens and becomes rigid and is arranged well below the triggering temperature of the glass vessel 1, and which softens and becomes tearable or dissolves (e.g. evaporates) at the triggering temperature. Basically, a simple foam and/or a foamed polymer may be used in this case, which absorbs shocks, which may occur transversely with respect to the longitudinal direction of the glass vessel 1, due to its buffer properties.

FIG. 4 shows an implementation of the reinforcement in which a material coated or impregnated with an auxetic material, or a material impregnated with a dilatant liquid, or a material obtained from a dilatant liquid, or a material which is hard and rigid and arranged far below the triggering temperature of the glass vessel 1, or thread which softens and tears at the triggering temperature or is formed from self-dissolving material, said thread being wound around at least one section of the glass vessel, in order to form the reinforcement.

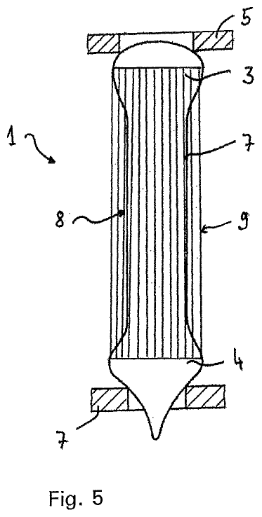

FIG. 5 shows an implementation of the reinforcement in which a protective curtain is formed, said curtain being made of, for example, textile threads, which are coated or impregnated with an auxetic material or impregnated with a dilatant liquid or which are formed from a material obtained from a dilatant liquid. The threads extend in a longitudinal direction of the glass vessel and are each connected to a circumferential retaining ring at longitudinal ends opposite one another. The retaining rings are established, e.g. bonded, on the thickened end sections 3 and 4 on the glass vessel 1 In the central section 8, the threads hang loose in the manner of a curtain but are tightened such that they extend at a distance from the outer wall 7 in the central section 8 and cannot be pressed against the outer wall 7 there. Instead of individual thread elements, the protective curtain may also be formed contiguously and in the manner of a sleeve, e.g. from a fabric having the previously described properties due to the described measures. This solution has the advantage that the protective curtain does not adhere to the central section 7 if the glass vessel 1 is triggered, that is when the glass vessel 1 ruptures due to achievement of the triggering temperature, and thereby does not change the triggering properties of the glass vessel 1.

However, the reinforcement (not shown here) may just as well be integrated into the rupturing material forming the outer wall.

In all the cases shown and also in other exemplary embodiments not shown here, the reinforcement 9 is always designed such that it results in a reinforcement of the vessel body 1 against shocks and comparable mechanical effects, which it may experience in a direction transverse with respect to its axial extension (that is transverse to the vertical in the figures). A triggering of the thermal triggering element (of the glass vessel) at the triggering temperature is thereby not impeded. Instead, if the triggering and/or response behavior of the glass vessel is approximately unchanged, particularly continued brief triggering and/or response times are ensured with the defined triggering temperatures. In particular, the reinforcement does not impede the transport of heat in the direction of the cavity and the triggering fluid arranged therein; it influences them at most in such a minimal manner that the triggering characteristics of the thermal triggering element are not changed.

This protection against shocks and comparable mechanical effects according to the invention is implemented externally in that the reinforcement contains an auxetic material and/or one or more dilatant liquids (or a material produced therefrom, e.g. a foam) and/or has a material, which is solid and rigid in a temperature range below a specified triggering temperature of the triggering element, said material being flexible at the triggering temperature.

If an auxetic material is used, it is oriented in the reinforcement in such a manner that it exhibits a reinforcing effect on the outer wall upon the application of external force directed transversely to the axial direction.

This design according to the invention obtains the advantage that a thermal triggering element thus formed is protected against undesired damage due to external mechanical influence, particularly shocks, not only during handling during assembly but also later in use; however, said triggering element simultaneously furthermore reliably triggers and does so with the necessary quick response time regarding the set triggering temperature.

### LIST OF REFERENCE NUMERALS

1 Vessel body
2 Cavity
3 End section
4 End section
5 Bearing element
6 Bearing element
7 Outer wall
8 Central section
9 Reinforcement

1. A thermal triggering element comprising:
a vessel body having an outer wall formed from a rupturing material;
a cavity enclosed by the outer wall and which is situated in an interior of the vessel body;
a triggering liquid enclosed in the cavity;
wherein the vessel body is formed so as to extend along an axial direction, with a tubular central section of the vessel body extending in the axial direction, and with two end sections which are situated at respective axial ends of the tubular central section; and in which the cavity is closed off in the manner of a cap;
wherein the triggering element has a permanently acting reinforcement which reinforces the rupturing material with respect to shock loads acting transversely with respect to the axial direction.

2. The thermal triggering element according to claim 1, wherein the reinforcement contains auxetic material, wherein the auxetic material is oriented in a manner such that it exhibits a reinforcing effect on the outer wall upon an external application of force directed transversely with respect to the axial direction.

3. The thermal triggering element according to claim 1, wherein the reinforcement has one or more dilatant liquids or a material produced therefrom.

4. The thermal triggering element according to claim 1, wherein the reinforcement has a material which is solid and stiff in a temperature range below an intended triggering temperature of the triggering element, and wherein the material is flexible at the triggering temperature.

5. The thermal triggering element according to claim 1, wherein the reinforcement has a textile structure which is produced, impregnated, or coated with an auxetic material, one or more dilatant liquids, or a material produced from one or more dilatant liquids, and/or from a material which is solid and stiff in a temperature range below an intended triggering temperature of the triggering element and which is flexible at the triggering temperature.

6. The thermal triggering element according to claim 1, wherein the reinforcement comprises a coating applied to an outer side of the outer wall, or a collar placed on the outer side of the outer wall, or a protective curtain arranged on the outer side of the outer wall.

7. The thermal triggering element according to claim 1, wherein the reinforcement is provided essentially along the entire tubular central section.

8. The thermal triggering element according to claim 1, wherein the reinforcement is a water-soluble material or a water-soluble carrier material.

9. The thermal triggering element claim 1, wherein the rupturing material is glass.

10. The thermal triggering element according to claim 3, wherein the one or more dilatant liquids or the material produced therefrom is a foam.
